(19) United States
(12) Patent Application Publication
(10) Pub. No.: US 2021/0023859 A1
(43) Pub. Date: Jan. 28, 2021

(54) NIPPING ROLLERS

(71) Applicant: Hewlett-Packard Development Company, L.P., Spring, TX (US)

(72) Inventors: Pavel Epshtein, Ness Ziona (IL); Boaz Eden, Ness Ziona (IL)

(73) Assignee: Hewlett-Packard Development Company, L.P., Spring, TX (US)

(21) Appl. No.: 16/975,847

(22) PCT Filed: Apr. 10, 2018
(86) PCT No.: PCT/US2018/026933

§ 371 Date: Aug. 26, 2020

(51) Int. Cl. B41J 13/02; B41J 13/03; B41J 13/076

(52) U.S. Cl. CPC B41J 13/025; B41J 13/22; B41J 13/076; B41J 13/03

(57) ABSTRACT

Examples of the present disclosure relate to a device for guiding a sheet, the device comprising a nip rollers arrangement comprising two nipping surfaces between a common drive roller and two freewheeling rollers aligned along a common direction and a freewheeling shaping element located between the two nipping surfaces along the common direction whereby the shaping element defines a shaping surface between the two nipping surfaces. The shaping element is displaceable between a first and a second position along a direction perpendicular to the common direction. The shaping surface is on a first side of the nipping surfaces when the shaping element is in the first position and the shaping surface is on a second opposite side of the nipping surfaces when the shaping element is in the second position.

### BACKGROUND

Handling material in the form of sheets can involve nipping rollers. Such nipping rollers transmit a guiding force to the sheet material which results in a displacement of the material in a direction tangential to the circumference of the rollers. Such material in the form of sheet may be a printing media and nipping rollers can be used to displace printing media along a media path.

### BRIEF DESCRIPTION OF THE DRAWINGS

Various example features will be apparent from the detailed description which follows, taken in conjunction with the accompanying drawings, wherein:

FIGS. 1A-B are schematic illustrations of an example device according to the present disclosure.

FIGS. 2A-B are schematic illustrations of an example device according to the present disclosure in another orientation.

FIGS. 3A-B are schematic illustrations of another example device according to the present disclosure.

FIG. 4 is a schematic illustration of a further example device according to the present disclosure.

FIGS. 5A-B are schematic illustrations of another example device according to the present disclosure.

FIGS. 6A-D are schematic illustrations of another example device according to the present disclosure.

FIGS. 7A-B are schematic illustrations of example printing systems according to the present disclosure.

FIGS. 8A-B are block diagrams representations of example methods to guide a sheet according to the present disclosure.

### DETAILED DESCRIPTION

This disclosure relates to handling material in a sheet form. Material in the form of a sheet may be a flexible material which may tend to bend or curl, for example if it is not held. In some examples, curling may take place at the leading edge of a sheet when a sheet travels. In such cases, the leading edge may get caught below or above the rest of the sheet, leading to a possible malfunction of a sheet handling device. In some instances, bending or curling may have consequences due to a misalignment which may lead to a so-called jam or paper jam. While some sheet material are subject to curling due to their flexibility, other types of sheet material may be less flexible and thereby less prone to curling. In this disclosure a device, a system and a method are proposed which may permit controlling flexibility of sheet material prone to curling while having a reduced impact on processing more rigid sheet material or sheet.

The solution proposed in the present disclosure involves shaping a sheet when such sheet is thin. The shaping takes place in such a manner that the rigidity of the sheet is increased by the shaping, making the sheet more rigid along the travel direction of the sheet, thereby reducing the possibility of curling. The solution of the disclosure is such that a thicker sheet, which may intrinsically be more rigid than a thinner sheet, may not be shaped. Such a selective handling differentiating between a thinner and a thicker sheet may solve curling for thinner sheets, without impacting the handling of thicker sheets for which curling may not take place. As will be illustrated in this disclosure, such shaping may take place through a shaping element, such shaping element exerting a shaping force onto a nipped sheet, the shaping force having a component normal to the plane of the sheet, such shaping force being for example originating from gravity by using the weight of the shaping element, the shaping element being placed above the sheet, or originating from other sources, such as mechanical or electrical, for example comprising a spring or piezo element, or from a combination of gravity and other sources.

Such solution may be implemented in numerous technological fields where sheets are processed. Such sheets may be of a variety of materials, such as metallic sheets, paper sheets, sheets made of plastic resins, laminated sheets, or a combination of these. The solution may for example enable transport of sheets in a manufacturing environment, in a packaging environment, in a printing environment or in a printed media processing environment including for example in folding machinery.

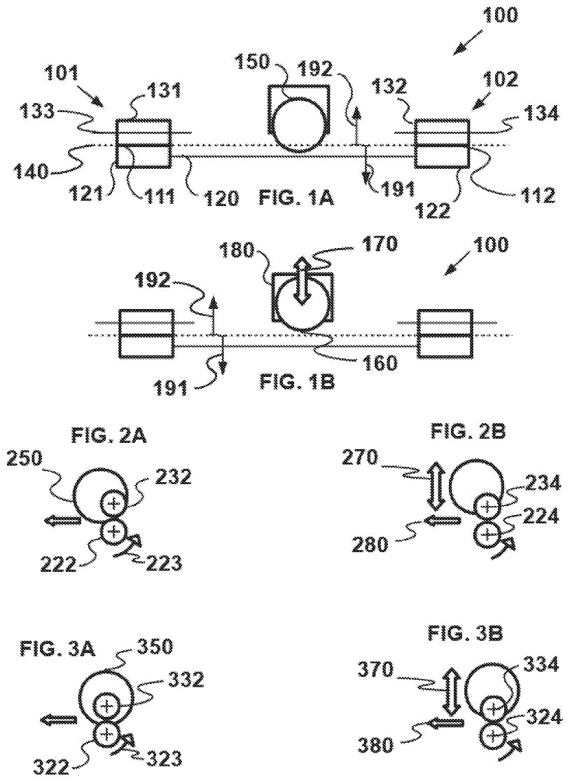

FIGS. 1A and 1B illustrate an example device 100 according to this disclosure. Device 100 is for guiding a sheet. A sheet is a substantially planar piece of material having a substantially constant thickness. In an example, the sheet is a rectangular sheet. In an example, the sheet has a standard size such as an ANSI A size including an A1, A2, A3, A4 or A5 size for example. Other examples include ANSI B sizes including B0, B1, B2, B3 or B4. In an example, the sheet has a thickness of more than 60 microns. In an example, the sheet has a thickness of less than 800 microns. In an example, the sheet weighs more than 70 grams per square meter. In an example, the sheet weighs less than 600 grams per square meter.

The device 100 comprises nip rollers arrangements 101 and 102. Nip rollers are roller arrangements forming a nipping region between two adjacent parallel rollers. A roller is a cylindrical element. A cylindrical roller may have a circular cross section. A roller may rotate around an axis. A cylindrical roller may rotate around the axis of the cylinder. Nipping may be produced by providing a limited clearance between external surfaces of two adjacent parallel cylindrical rollers. Nipping may be produced by maintaining parallel cylindrical rollers in contact. Nipping may be produced by pushing parallel cylindrical rollers towards each other, for example using a spring mechanism. Nipping should permit passage of a sheet between nip rollers, the nip rollers exerting a friction force on both sides of the sheet.

The nip rollers 101 and 102 comprise two nipping surfaces 111 and 112. Having two nipping surfaces permits driving a sheet in a symmetrical manner. A single nipping surface may produce jamming. The nipping surfaces are tangential to the surface of the rollers in a region where the rollers are facing each other. When a sheet is engaged in the device, the sheet is nipped in the nipping surface region between the rollers. When a sheet is nipped, there is a surface of contact of the sheet with the rollers, one roller on one side of the sheet and the other roller on the other side of the sheet, such surface of contact corresponding to the nipping surface.

The nipping surfaces 111 and 112 are between a common drive roller 120, 121, 122 and two freewheeling rollers 131 and 132. A common drive roller 120, 121, 122 permits transmitting a common speed to a sheet nipped in the two nipping surfaces 111 and 112 at the same time. Using a common speed in the two nipping surface regions through a common drive roller 120, 121, 122 reduces a risk of transmitting different speeds to a same sheet, which could result in jamming a sheet in the device 100. In an example, the common drive roller is made of several elements, having a single axle 120 on which elements 121 and 122 are placed to form the nipping surfaces. In an example, the common drive roller is made of a single piece. In an example, axle 120 is made of a material different from the material making roller elements 121 and 122. Rollers 131 and 132 are facing the common drive roller to form the nipping surfaces. Rollers 131 and 132 are freewheeling in order to avoid transmitting different speeds to a sheet. Freewheeling rollers are free to rotate around an axis 133 or 134 without mechanical constraint. The freewheeling rollers will adapt their speed to a sheet passing in the nipping surfaces, the sheet being driven at the speed communicated by the common drive roller. The common drive roller 120, 121, 122 and the freewheeling rollers 131 and 132 are aligned along a common direction 140. According to such alignment, the common direction 140 is parallel to the axis of rotation of the drive roller and parallel to the axis of rotation of each freewheeling roller. In an example, the freewheeling rollers and the common drive roller are in the region of the nipping surfaces cylindrical with a circular cross section,

Device 100 comprises a freewheeling shaping element 150 located between the two nipping surfaces 111 and 112 along the common direction 140, the shaping element 150 defining a shaping surface between the two nipping surfaces. In an example, the shaping element is located in a central region between the two nipping surfaces. Being located between the nipping surfaces, the shaping element 150 will mechanically interact with a sheet nipped in the nipping surfaces. In an example, the shaping element is freewheeling around the axis parallel to the common direction such that its interaction with a sheet guided by the device would be limited as far as friction between the shaping element and the sheet is concerned. Freewheeling permits applying a force onto the sheet with a component reduced in a direction of the plane of the sheet compared to the component of such interaction force in a direction normal to the plane of the sheet.

The shaping element 150 is displaceable between a first and a second position along a direction 170 perpendicular to the common direction 140. The shaping element is in the first position in FIG. 1A and in the second position in FIG. 1B. While the first and the second positions are at different points along the direction perpendicular to the common direction, they may also be at different points in other directions. In other words, while the first and second positions are at different positions along the direction perpendicular to the common direction they may not being aligned along this direction perpendicular to the common direction. In an example the shaping element 150 is displaceable between a first and a second position along a direction 170 normal a plane comprising the shaping surface and the nipping surfaces. In device 100 represented in FIGS. 1A and 1A, the shaping element is a marble like element placed in a socket 180, the socket permitting displacement of the marble in the direction 170 perpendicular to common direction 140. The socket may permit movement in other directions also.

The shaping surface 160 is on a first side 191 of the nipping surfaces when the shaping element is in the first position as illustrated in FIG. 1A, and the shaping surface 160 is on a second opposite side 192 of the nipping surfaces when the shaping element is in the second position as illustrated in

FIG. 1B. In other words, the shaping surfaces crosses a plane comprising the nipping surfaces when the shaping element moves from the first to the second position. If a thin sheet is nipped in the device of this disclosure, the sheet will be shaped by the shaping element as the shaping element crosses the plane comprising the nipping surfaces. The contact area between the sheet and the shaping element is the shaping surface. In an example, a thick sheet is nipped, such that the thick sheet pushes the shaping element towards a position between the first and the second position furthest away from the plane comprising the nipping surfaces. In other words, a thin sheet may be mechanically shaped by the shaping element while a thicker sheet may maintain its original shape and push the shaping element into a position which prevents its shaping. This realizes the objective of the disclosure according to which a thinner sheet, more prone to curling, may be shaped by the shaping element in a direction such that curling is avoided, while a thicker sheet not prone to curling may not be affected by the shaping element as it pushes it out of the way. In an example, the shaping surface is of more than 5 square millimeters. In an example, the shaping area is of less than 25 square millimeters.

FIG. 2A is a representation of a device according to this disclosure such as device 100 seen from a side, when the shaping element 150 is in the position illustrated in FIG. 1A. FIG. 2B is a representation of the device 100 seen from a side, when the shaping element 150 is in the position illustrated in FIG. 1B. In FIGS. 2A and 2B the shaping element 250 is illustrated together with a drive roller 222 rotating around an axis 224 for example in a direction illustrated by arrow 223 resulting in guiding a sheet (not shown) in the direction illustrated by arrow 280. Between its position in FIG. 2A and its position in FIG. 2B, shaping element 250 is displaced along direction 270 perpendicular both to the axis 224, which is parallel or aligned with the common direction corresponding to common direction 140 of FIG. 1, and to the direction of movement 280 of a sheet guided through the device. A nipping surface is formed between the common drive roller 222 and a freewheeling roller 232 which is allowed to rotate freely around its axis 234 parallel or aligned to axis 224 of the common drive roller. The position of FIG. 2A corresponds to a position where the shaping element would shape a thin sheet, whereas position of FIG. 2B corresponds to a position where the shaping element may be pushed up by a thicker sheet. In the example of FIGS. 2A and 2B, the shaping surface is slightly offset from the nipping surfaces.

FIG. 3A is a representation of a device according to this disclosure such as device 100 seen from a side, when the shaping element 150 is in the position illustrated in FIG. 1A. FIG. 3B is a representation of the device 100 seen from a side, when the shaping element 150 is in the position illustrated in FIG. 1B, In FIGS. 3A and 3B the shaping element 350 is illustrated together with a drive roller 322 rotating around an axis 324 for example in a direction illustrated by arrow 323 resulting in guiding a sheet (not shown) in the direction illustrated by arrow 380. Between its position in FIG. 3A and its position in FIG. 3B, shaping element 350 is displaced along direction 370 perpendicular both to the axis 324, which is parallel or aligned with the common direction corresponding to common direction 140 of FIG. 1, and to the direction of movement 380 of a sheet guided through the device. A nipping surface is formed between the common drive roller 322 and a freewheeling roller 332 which is allowed to rotate freely around its axis 334 parallel or aligned to axis 324 of the common drive roller. The position of FIG. 3A corresponds to a position where the shaping element would shape a thin sheet, whereas position of FIG. 3B corresponds to a position where the shaping element may be pushed up by a thicker sheet. In the example of FIGS. 3A and 3B, the shaping surface is aligned with the nipping surfaces.

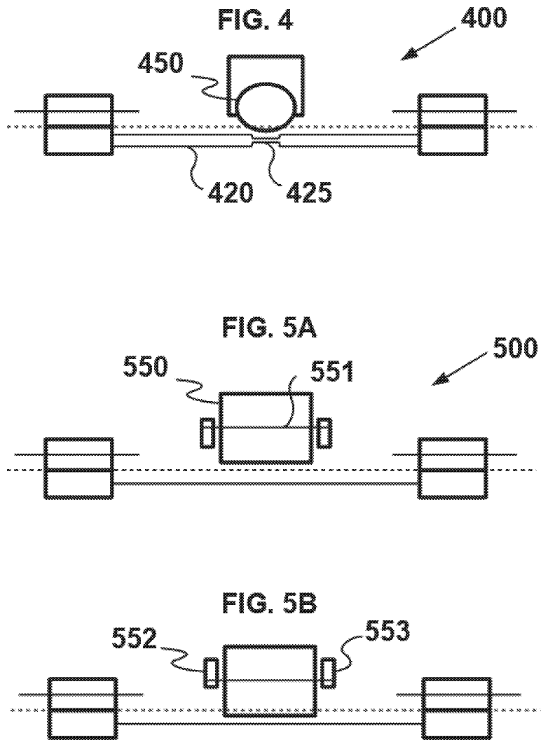

FIG. 4 illustrates a device 400 according to this disclosure, whereby the shaping element 450 is facing the drive roller, the drive roller comprising a depressed region 425 facing the shaping element. Such a depression may participate in shaping a thin sheet while having little to no impact on the handling or guiding of a thicker sheet. In an example, the depressed region is a concave recess corresponding to a complementing convex shape of the shaping element. In an example, the shaping element has a shape spreading the shaping force over a surface area to prevent damaging the sheet.

FIGS. 5A and 5B illustrate a device 500 according to this disclosure whereby a shaping element 550 is in a first position in FIG. 5A and in a second position in FIG. 5B. The shaping element 550 is cylindrical having a circular cross section and a cylinder axis parallel to the common direction, the cylindrical shaping element 550 freewheeling around its axis 551, the axis 551 being displaceable within rails 551 and 552, such rails permitting a displacement of the shaping element in the direction perpendicular to the common direction. When represented elements are not marked with reference numerals in Figures of this disclosure, such elements are similar to the corresponding elements of FIGS. 1A and 1B. The shaping element may take a number of different forms, for example cylindrical, ovoid, elliptical or spherical. In examples, the shaping element has a continuous convex external surface forming the shaping surface. Such surfaces may reduce the possibility to scratch or otherwise damage a sheet guided or transported by the device. The shaping element may cooperate with a support, the support being for example a socket or rails, such support permitting freewheeling of the shaping element and displacement of the shaping element according to this disclosure.

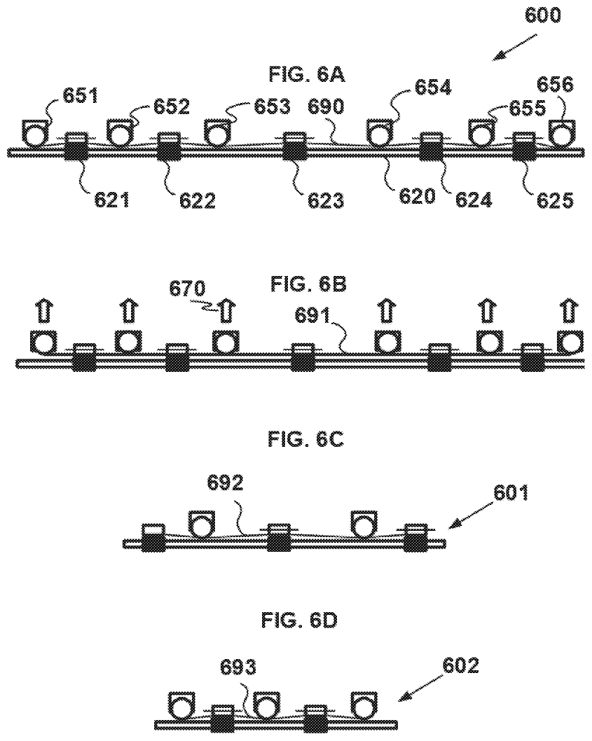

FIGS. 6A and 6B illustrate a device 600 according to this disclosure, the device 600 comprising additional nipping surfaces between additional freewheeling rollers and the common drive roller, and comprising additional shaping elements defining additional shaping surfaces, the shaping surfaces alternating with nipping surfaces along the common direction. More specifically, device 600 comprises a common drive roller 620 which cooperates with 5 freewheeling rollers to form 5 nipping surfaces. The 5 combination of a freewheeling roller and common drive roller are 621, 622, 623, 624 and 625. Device 600 further comprises 6 shaping elements 651, 652, 653, 654, 655 and 656. Shaping elements 652 to 655 are located between adjacent nipping surfaces. Shaping elements located on extremities of the device are adjacent to a single nipping surface. In FIG. 6A, device 600 is illustrated while guiding a thin sheet 690, the shaping elements shaping the thin sheet in a wave-like form by applying their weight onto the sheet. In FIG. 66, the same device 600 is illustrated while guiding a thicker sheet 691 which, due to its rigidity, compensates the force applied by the shaping elements, pushing them up along a direction 670 perpendicular to the common direction into a raised position, preventing a deformation of the sheet. The wave like form of the thin sheet 690 will improve its rigidity and reduce a risk of curling. A thicker sheet may not be submitted to curling and is elegantly prevented from shaping through the device of this disclosure. In an example, the nipping surfaces and shaping surfaces are alternating. In an example, the number of nipping surfaces and the number of shaping surfaces differs by one, which for example may permit a symmetrical design as in case of device 600.

FIGS. 6C and 6D illustrate example configurations of a device according to this disclosure. Device 601 comprises three roller arrangements and two shaping elements, each shaping element located between two of the roller arrangements. Device 601 is illustrated together with a thin sheet 692 which takes a shape having a profile in the form of a “W”. Device 602 comprises two roller arrangements and three shaping elements, each roller arrangement located between two of the shaping elements. Device 602 is illustrated together with a thin sheet 693 which takes a shape having a profile in the form of an “M”.

In an example, the direction perpendicular to the common direction is the direction of gravity. In such an example, the shaping element may exert a shaping force through its weight. In an example, the shaping element weighs more than 20 grams. In an example, the shaping element weighs less than 70 grams. In an example, the shaping force is limited to avoid damaging a sheet. In an example, the shaping element is located on the top side of a plane comprising the nipping surfaces, top being defined according to the direction of gravity. In another example, the shaping element may be located below the plane comprising the nipping surfaces and be pushed up to compensate its own gravity and exert a shaping force against gravity. In an example device, one or more shaping element are located below the plane comprising the nipping surfaces and one or more other shaping element are located above the plane comprising the nipping surfaces. Whether placed above or below the plane comprising the nipping surfaces, the corresponding shaping surface according to this disclosure will intersect such plane when moving from its first to its second position. In an example, the direction perpendicular to the common direction is the gravity and is normal to the plane comprising the nipping surfaces.

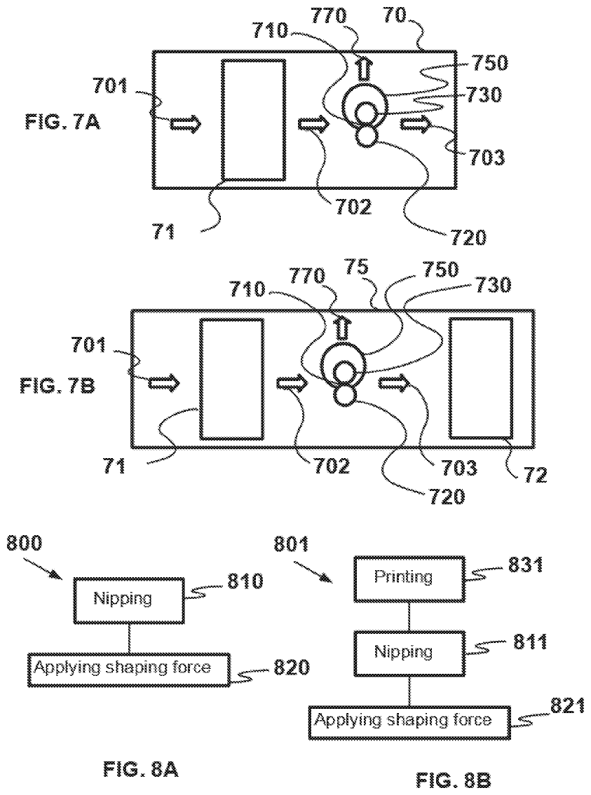

FIG. 7A illustrates a printing system 70 for printing on a media, the system 70 comprising a media path 701, 702, 703 and a printing station 71, the media path transporting media to and from the printing station, the media path comprising a downstream media path 702, 703 transporting printed media from the printing station, the downstream media path comprising:
two nipping surfaces 710 between a common drive roller 720 and two freewheeling rollers 730 aligned along a direction perpendicular to a media path direction;
a shaping element 750 located between the two nipping surfaces along the direction perpendicular to the media path direction, the shaping element 750 defining a shaping surface between the nipping surfaces 710, whereby:
the shaping element 750 is displaceable between a first and a second position along a direction 770 perpendicular to the media path direction;
the shaping surface is on a first side of the nipping surfaces 710 when the shaping element is in the first position; and
the shaping surface is on a second opposite side of the nipping surfaces 710 when the shaping element is in the second position.

In the representation of FIG. 7A, while a first freewheeling roller 730 and nipping surface 710 is represented, a second freewheeling roller and second nipping surface is present but not represented. In another example printing system 75 illustrated by FIG. 76, the nipping surfaces are between the print station 71 and a stacker 72.

In an example, printing station 71 is an industrial or commercial printing station. In an example, the media path moves print media in the form of sheets. In an example, the media path processes media at a speed of more than 1 meter per second. In an example, the media path processes media at a speed of more than 2.5 meters per second. Such speed corresponds to a circumferential speed of the common drive roller of the disclosure. Higher speeds of displacement of a sheet, such as for example print media, may increase the possibility of jamming of thin sheets, such jamming being controllable according to this disclosure.

FIG. 8 illustrates a method 800 to guide a sheet according to this disclosure. Method 800 comprises in block 810 nipping a sheet between a drive roller and freewheeling rollers to guide the sheet in a travel direction; and in block 810 applying a shaping force on the sheet in a direction perpendicular to a plane defined by the sheet in a region between the freewheeling rollers, whereby the shaping force is applied by a freewheeling shaping element, the shaping element being moveable along a direction normal to the sheet such that a sheet having a thickness below a threshold will be shaped by the force and a sheet having a thickness above the threshold will apply a reacting force compensating the shaping force. In an example, the threshold is between 70 and 800 micrometers. In another example, the threshold is between 150 and 700 micrometers. In another example, the threshold is between 300 and 500 micrometers.

In an example, the weight of the shaping element contributes to the shaping force. Other contributions to the shaping force may be introduced by a spring, a magnet, whether a permanent magnet or an electromagnet, a piezo element or by an electrical motor for example.

In an example, the shaping increases the rigidity of a sheet having a thickness below the threshold when the sheet has passed nipping. In an example, a plurality of shaping elements and nipping freewheeling rollers are aligned and alternate to shape such a sheet with a wave like profile in a plane normal to a travelling direction of the sheet.

In an example, the sheet is printed with ink prior to the nipping, for example using printing station 71, the shaping element being in contact with the ink. Such a freewheeling shaping element will avoid scratching the sheet and avoid affecting the quality of a print. In an example, the freewheeling rollers are in contact with the ink.

The preceding description has been presented to illustrate and describe certain examples. Different sets of examples have been described; these may be applied individually or in combination, sometimes with a synergetic effect. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A device for guiding a sheet, the device comprising:
a nip rollers arrangement comprising two nipping surfaces between a common drive roller and two freewheeling rollers aligned along a common direction;
a freewheeling shaping element located between the two nipping surfaces along the common direction, the shaping element defining a shaping surface between the two nipping surfaces, whereby:
the shaping element is displaceable between a first and a second position along a direction perpendicular to the common direction;
the shaping surface is on a first side of the nipping surfaces when the shaping element is in the first position; and
the shaping surface is on a second opposite side of the nipping surfaces when the shaping element is in the second position.

2. A device according to claim 1, whereby the shaping element is facing the drive roller, the drive roller comprising a depressed region facing the shaping element.

3. A device according to claim 1, whereby the shaping element is cylindrical, the cylindrical shaping element having a cylinder axis parallel to the common direction.

4. A device according to claim 1, whereby the shaping element has an ovoid, elliptical or spherical shape.

5. A device according to claim 1, the device further comprising:
additional nipping surfaces between additional freewheeling rollers and the drive roller and;
additional shaping elements defining additional shaping surfaces, the shaping surfaces alternating with nipping surfaces along the common direction.

6. A device according to claim 5, whereby the number of nipping surfaces and the number of shaping surfaces differs by one.

7. A device according to claim 1, whereby the direction perpendicular to the common direction is the direction of gravity.

8. A printing system for printing on a media, the system comprising a media path and a printing station, the media path transporting media to and from the printing station, the media path comprising a downstream media path transporting printed media from the printing station, the downstream media path comprising:
two nipping surfaces between a common drive roller and two freewheeling rollers aligned along a direction perpendicular to a media path direction;
a shaping element located between the two nipping surfaces along the direction perpendicular to the media path direction, the shaping element defining a shaping surface between the nipping surfaces, whereby:
the shaping element is displaceable between a first and a second position along a direction perpendicular to the media path direction;
the shaping surface is on a first side of the nipping surfaces when the shaping element is in the first position; and
the shaping surface is on a second opposite side of the nipping surfaces when the shaping element is in the second position.

9. A printing system according to claim 8, whereby the nipping surfaces are between the print station and a stacker.

10. A method to guide a sheet, the method comprising:
nipping a sheet between a drive roller and freewheeling rollers to guide the sheet in a travel direction;
applying a shaping force on the sheet in a direction perpendicular to a plane defined by the sheet in a region between the freewheeling rollers, whereby the shaping force is applied by a freewheeling shaping element, the shaping element being moveable along a direction normal to the sheet such that a sheet having a thickness below a threshold will be shaped by the force and a sheet having a thickness above the threshold will apply a reacting force compensating the shaping force.

11. A method according to claim 10, whereby the weight of the shaping element contributes to the shaping force.

12. A method according to claim 10, whereby the shaping increases the rigidity of a sheet having a thickness below the threshold when the sheet has travelled passed nipping.

13. A method according to claim 12, whereby a plurality of shaping elements and nipping freewheeling rollers are aligned and alternate to shape the sheet with a wave like profile in a plane normal to a travelling direction of the sheet.

14. A method according to claim 10, whereby the shaping element has a shape spreading the shaping force over a surface area to prevent damaging the sheet.

15. A method according to claim 14 whereby the sheet is printed with ink prior to the nipping, the shaping element being in contact with the ink.
